(19) United States
(12) Patent Application Publication
(10) Pub. No.: US 2004/0172441 A1
(43) Pub. Date: Sep. 2, 2004

(54) Systems and methods for defining conversation information for web-services

(76) Inventors: Dorothea Beringer, Sergy (FR); Guillaume Vambenepe, Mountain View, CA (US)

Correspondence Address: HEWLETT-PACKARD COMPANY, Intellectual Property Administration, P. O. Box 272400, Fort Collins, CO, 80527-2400, US

(21) Appl. No.: 10/376,699

(22) Filed: Feb. 28, 2003

(51) Int. Cl. G06F 15/16

(52) U.S. Cl. 709/200

(57) ABSTRACT

In accordance with an embodiment of the present invention, a web-services interface for a web-service comprises an initial operations element operable to specify at least one operation of a plurality of operations of the web-service as an initial operation of the conversation, a final operations element operable to specify at least one operation of the plurality of operations as a final operation of the conversation, and a transitions element operable to specify a transition from at least one of the plurality of operations to at least another one of the plurality of operations.

© Hewlett-Packard Company 2001-03. A portion of the disclosure of this patent document contains material which is subject to copyright protection. The copyright owner has no objection to the facsimile reproduction by anyone of the patent document or the patent disclosure in its entirety, as it appears in the patent and trademark office patent file or records, but otherwise reserves all copyright rights whatsoever.

### TECHNICAL FIELD OF THE INVENTION

The present invention relates generally to the field of web-services, and more particularly to systems and methods for defining conversation information for web-services.

### BACKGROUND OF THE INVENTION

WSDL (Web Services Description Language) is a web-services description language that describes web-services by specifying parts, messages, operations, ports, port types, and services. The specification for WSDL 1.1 is available at http://www.w3.org/TR/wsdl. WSDL comprises an XML (eXtensible Markup Language) vocabulary that standardizes how organizations describe web-services. A WSDL document includes various elements, which define and describe the web-services offered by the author of the WSDL document, for example a service provider.

BizTalk Messaging Framework is a messaging framework that provides specifications for the design and development of messaging solutions for communication between applications and organizations. This specification builds upon standard and emerging Internet technologies, such as Hypertext Transfer Protocol (HTTP), Multipurpose Internet Mail Extensions (MIME), XML, and Simple Object Access Protocol (SOAP). The BizTalk Messaging Framework specifies the format of a web-services message. It defines various SOAP header elements, such as a “process” element.

Service requesters can access web-services remotely across the Internet using various protocols, for example SOAP or BizTalk Messaging Framework. Using WSDL a service provider can inform service requesters on how to access and use services provided by the service provider. The service providers use WSDL to describe how their services can be used and to describe how the messages for interacting with the services are to be built. The interaction between the service provider and the service requestor is achieved through message exchange.

However, merely defining what messages may be exchanged between the service provider and the service requester is not sufficient to have a meaningful conversation between the service provider and the service requestor. WSDL does not specify the sequence or order in which messages may be exchanged or the sequence or order in which operations may be invoked.

### SUMMARY OF THE INVENTION

In accordance with an embodiment of the present invention, a web-service interface for a web-service comprises an initial operations element operable to specify at least one operation of a plurality of operations of the web-service as an initial operation of the conversation, a final operations element operable to specify at least one operation of the plurality of operations as a final operation of the conversation, and a transition element operable to specify a transition from at least one of the plurality of operation to at least another one of the plurality of operations.

In accordance with another embodiment of the present invention, a method for defining a web-service comprises defining a web-services interface for the web-services service, the web-services interface comprising a conversation element extension operable to inform a service requestor regarding a predetermined order for invoking a plurality of operations of the web-service.

In accordance with yet another embodiment of the present invention, a method for providing a web-service comprises determining whether a received message is part of an existing conversation, determining whether a web-services interface for the web-service defines a transition from a preceding operation to an operation requested by the message, in response to the message being part of an existing conversation, updating a state of the existing conversation to the operation requested by the message in response to the web-services interface defining a transition from the preceding operation to the requested operation and processing the message.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is a logical block diagram of a system which may use embodiments of the present invention to advantage;

FIG. 2 is a high level block diagram of a system which may use embodiments of the present invention to advantage;

FIG. 3 is a diagram of a schema for a conversation element extension in accordance with an embodiment of the present invention;

FIG. 4A is a diagram of an exemplary web-services interface that comprises a conversation element extension in accordance with an embodiment of the present invention;

FIG. 4B illustrates an exemplary finite state machine corresponding to the exemplary web-services interface of FIG. 4A; and

FIG. 5 is a flowchart of an exemplary method for processing, by an actor, a message in a conversation in accordance with an embodiment of the present invention.

### DETAILED DESCRIPTION OF THE DRAWINGS

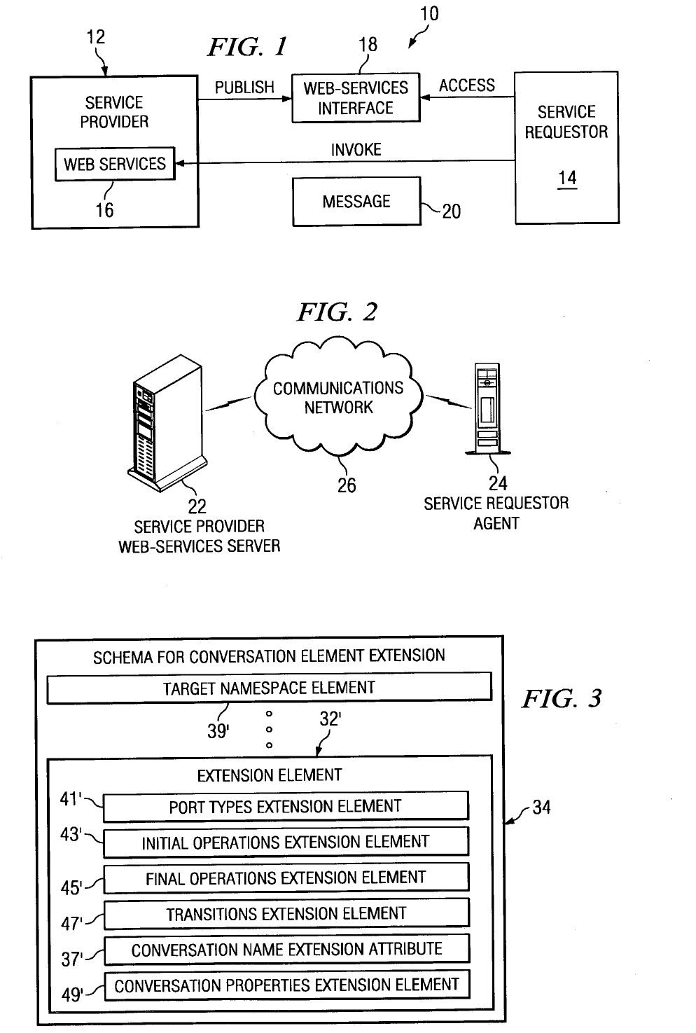

The preferred embodiment of the present invention and its advantages are best understood by referring to FIGS. 1 through 5 of the drawings, like numerals being used for like and corresponding parts of the various drawings.

A service provider and a service requester may have a conversation by exchanging messages. A web-services interface, for example a Web Services Description Language (WSDL) document, may describe a plurality of services supported by the service provider. The WSDL document may also provide information as to the types of messages that may be exchanged between the service provider and the service requestor. However, WSDL does not specify the sequence or order in which messages may be exchanged or the sequence or order in which operations may be invoked. Some services might require that certain operations be performed before certain other operations may be initiated. This in turn would require that certain messages be exchanged before certain other messages.

In order to facilitate a meaningful conversation between the service provider and the service requester, it is desirable that each party be aware of the sequence in which messages may be exchanged between them. Thus, there is a desire for a system and method for defining conversation information for web-services to facilitate conversations between the service provider and the service requester.

Accordingly, a schema is provided which may be used by the service provider to define one or more web-services. Preferably, a conversation between actors comprises exchange of one or more messages between the actors. The terms “actor” or “actors” is used herein to refer to participants in a conversation, for example the service provider and the service requestor. The definition of the web-service preferably comprises a conversation element extension, which defines or specifies the ordered sequence in which operations may be requested and/or messages may be exchanged between the actors. The messages may be web-services messages and may be in accordance with an asynchronous messaging framework, such as BizTalk Messaging Framework or Simple Object Access Protocol (SOAP). When the actor receives a message, such as a web-services document or an XML (extensible Markup Language) document, which includes the desired information in the sequence specified by the schema, the actor is able to respond to the message appropriately. The schema for defining at least part of the conversation may be specified once for one or more industries and then bound to different protocols and used by any number of services with different implementations.

FIG. 1 is a logical block diagram of a system 10 which may use embodiments of the present invention to advantage. System 10 comprises a service provider 12 and a service requester 14. Service provider 12 is a provider of at least one web-service 16. Service provider 12 publishes at least one web-services interface 18. Web-services interface 18 preferably comprises a WSDL interface, for example a WSDL document. Web-services interface 18 defines the web-services that service provider 12 is capable of providing. Service requester 14 requests one or more web-services 16 by transmitting a message 20 to service provider 12. A conversation between service provider 12 and service requestor 14 preferably comprises of one or more messages. Web-services interface 18 may define or specify the format for message 20 that service provider 12 may receive from service requester 14. Alternatively, the format for message 20 may be agreed upon between service provider 12 and service requestor 14 in advance of the message being sent to service provider 12. The format of message 20 corresponds to the format defined by web-services interface 18 for the particular web-service being invoked/requested and each message 20 preferably invokes operations within the particular web-service in the sequence specified by web-services interface 18. Message 20 may be a SOAP document, a message utilizing the BizTalk Messaging Framework specification and/or the like.

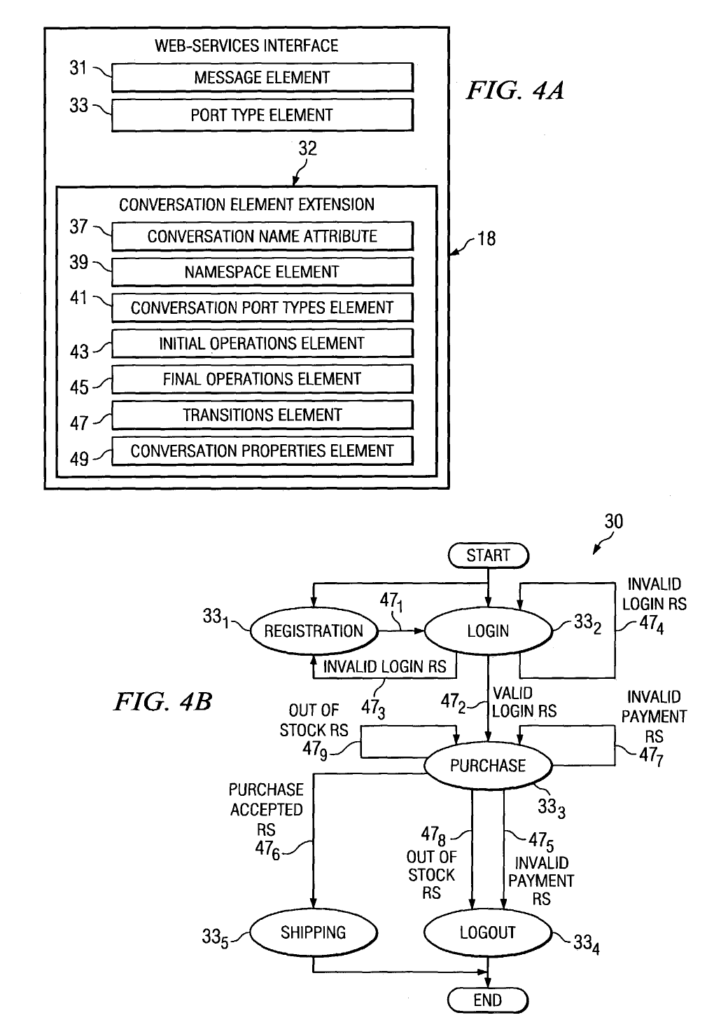

Referring also to FIG. 2, in an exemplary embodiment, a service provider web-services server 22 is communicatively coupled with a service requester agent 24. Web-services server 22 may be provided by service provider 12. Web-services server 22 is capable of providing web-services 16. Web-services server 22 may comprise a plurality of ports (not shown). A port may correspond to one or more operations of the web-service. Service requester 14 may utilize service requester agent 24 to request web-services from web-services server 22 and/or invoke operations on web-services server 22 via a communications network 26. Schema 34 of FIG. 3 provides guidance for creating a web-services interface, for example web-services interface 18 of FIG. 4A, which preferably specifies the sequence in which operations of a particular web-service provided by service provider 12 may be invoked. Thus, schema 34 provides guidance to service provider 12 for creating a web-services interface, for example web-services interface 18, which in turn provides guidance to service requester 14 desiring to invoke the web-service by means of a conversation with service provider 12.

FIG. 3 is a diagram of schema 34 for a conversation element extension in accordance with an embodiment of the present invention. An exemplary schema is provided in APPENDIX A. A portion of an exemplary web-services interface in accordance with schema 34 is provided in APPENDIX B. Schema 34 comprises of a plurality of elements. These elements are discussed in detail hereinafter.

Schema 34 comprises a target namespace element 39′, for example <xsd:schematargetNamespace=“http://schemas.hp.com/web-services/wsdl/conversations”>. Target namespace element 39′ preferably defines an identifier, for example a Uniform Resource Locator (URL) (http://schemas.hp.com/web-services/wsdl/conversations), that uniquely references an extension to a specification, for example a conversation element extension to a specification of a web-services description language. The identifier specified in a namespace element 39 of a conversation element extension 37 of exemplary web-services interface 18 (FIG. 4A) preferably corresponds to the identifier defined in target namespace element 39′.

Schema 34 comprises an extension element 32′, which defines a conversation. Following is an exemplary extension element:

Extension element 32′ is of type conversationType. In the example of APPENDIX A, an extension definition element defines an element of type conversationType. Following is an example of an extension definition element:

<xsd:complexType name=“conversationType”>

. . .

</xsd:complexType>

The extension definition element comprises a sequence sub-element xsd:sequence. Following is an example of a sequence sub-element:

<xsd:sequence>

<xsd:element name=“portTypes” minOccurs=“0”>

. . .

</xsd:element>
<xsd:element name=“initialOperations”>

. . .

</xsd:element>
<xsd:element name=”finalOperations”>

. . .

</xsd:element>
<xsd:element name=“transitions”>

. . .

</xsd:element>

</xsd:sequence>

The sequence sub-element preferably provides a list of elements which comprise extension element 32′ and which according to schema 34 are to be defined in a web-services interface, for example web-services interface 18. Extension element 32′ comprises a plurality of elements, such as a port types extension element 41′, an initial operations extension element 43′, a final operations extension element 45′, and a transitions extension element 47′, as listed in the above sequence sub-element. An element listed in the sequence sub-element may be further defined. In the above example, port types element 41′ is further defined as having a minimum occurrence value of zero (minOccurs=“0”), which indicates that this element is optional in web-services interface 18.

An element of the schema may have a documentation sub-element within an annotation sub-element. For example, in the example of APPENDIX A, port types extension element 41′ comprises the following annotation element:

<xsd:annotation>

<xsd:documentation>Gives a list of the port
types from which operations appear
in this conversation.</xsd:documentation>

</xsd.annotation>

The documentation sub-element specifies the function of the element to which it belongs in human-readable form so that an actor, for example a service provider, could understand the format in which a web-services interface conforming to the schema may be built.

Following is a definition for port types extension element 41′:

<xsd:element name=“portTypes” minOccurs=“0”>

<xsd:annotation>

<xsd:documentation>Gives a list of the port types
from which operations
appear in this conversation.</xsd:documentation>

</xsd.annotation>
<xsd:complexType>

<xsd:sequence>

<xsd:element name=“portType” type=
“xsd:QName”
maxOccurs=“unbounded”/>

</xsd:sequence>

</xsd:complexType>

</xsd:element>

A service may comprise of one or more operations. For example, a StoreFrontService may comprise of one or more of the following operations—Registration, Login, Purchase, Logout and Shipping. According to the above definition, a conversation port types element 41 of web-services interface 18 (FIG. 4A) preferably specifies the port types or operations that comprise the web-service. According to the above example, conversation port types element 41 preferably comprises a port type element of type QName. In general, QName stands for qualified name and is preferably composed of a prefix followed by a colon and a name, for example, conv:conversation. A port type element has no minimum occurrence value and a maximum occurrence (maxOccurs) value of “unbounded”, which indicates that conversation port types element 41 of web-services interface 18 may comprise one or more port type elements. If desired, conversation port types element 41 may refer back to one or more previously defined port types in the WSDL document.

Following is a definition for initial operations extension element 43′:

<xsd:element name=“initialOperations”>

<xsd:complexType>

<xsd:sequence>

<xsd:element name=“initialOperation”
type=“conv:referencedOperation
” maxOccurs=“unbounded”/>

</xsd:sequence>

</xsd:complexType>

</xsd:element>

According to the above definition, an initial operations element 43 of web-services interface 18 (FIG. 4A) preferably specifies operation(s) that may act as the starting or initial operation for the web-service. During a conversation between the actors, at least one of the specified operations are invoked or requested prior to any other operation for the web-service being specified. According to the above example, initial operations element 43 preferably comprises an initial operation element of type referencedOperation, which is defined hereinbelow. An initial operation element has no minimum occurrence value and a maximum occurrence (maxOccurs) value of “unbounded”, which indicates that initial operations element 43 of web-services interface 18 may comprise one or more initial operation elements.

Following is a definition for final operations extension element 45′:

<xsd:element name=”finalOperations”>

<xsd:complexType>

<xsd:sequence>

<xsd:element name=“finalOperation”
type=“conv:referencedOperation”
maxOccurs=“unbounded”/>

</xsd:sequence>

</xsd:complexType>

</xsd:element>

According to the above definition, a final operations element 45 of web-services interface 18 (FIG. 4A) preferably specifies operation(s) that may act as the ending or final operation for the web-service. At least one of the specified operations ends the conversation between the actors for the particular web-service. According to the above example, final operations element 45 preferably comprises a final operation element of type referencedOperation, which is defined hereinbelow. A final operation element has no minimum occurrence value and a maximum occurrence (maxOccurs) value of “unbounded”, which indicates that final operations element 45 of web-services interface 18 may comprise one or more final operation elements.

Following is a definition for transitions extension element 47′:

<xsd:element name=“transitions”>

<xsd:complexType>

<xsd:sequence>

<xsd:element name=“transition” minOccurs=“0”
maxOccurs=“unbounded”>

<xsd:complexType>
<xsd:sequence>
<xsd:element name=“sourceOperation”
type=“conv:referencedOperation”/>
<xsd:element name=“destinationOperation”
type=“conv:referencedOperation”/>
<xsd:element name=“sourceOperationCondition”
type= “xsd:QName” minOccurs=“0”>

<xsd:annotation>
<xsd:documentation>References the name
of an input, output, or
fault element of the
sourceOperation.</xsd:documentation>
</xsd:annotation>

</xsd:element>
</xsd:sequence>
</xsd:complexType>

</xsd:element>

</xsd:sequence>

</xsd:complexType>

</xsd:element>

According to the above definition, a transitions element 47 of web-services interface 18 (FIG. 4A) preferably specifies the permissible transitions from one operation to another. Transitions element 47 preferably comprises a transition element. A transition element defines an enabled transition from one operation to another operation. A transition element has a minimum occurrence value of zero (minOccurs=“0”) and a maximum occurrence (maxOccurs) value of “unbounded”, which indicates that transitions element 47 of web-services interface 18 may comprise zero or more transition elements.

According to the schema of APPENDIX A, a transition element may comprise of a plurality of elements, such as a source operation element, a destination operation element, and/or a transition condition element. A source operation element is preferably of the type referencedOperation. A destination operation element is preferably of the type referencedOperation. A transition condition element is preferably of the type QName and has a minimum occurrence value of zero, which indicates that transition condition element is optional. The source operation element specifies a source operation for the transition and the destination operation element specifies a destination operation for the transition. A conversation may transition from the source operation to the destination operation. The transition condition element specifies the condition the validity of which causes the transition from the source operation to the destination operation to be valid. The transition condition preferably references a specific input, output or fault message that has to be exchanged in order for the transition from the source operation to the destination operation to be authorized or enabled. As can be seen from the definition of an element of type referencedOperation provided herein below, the source and/or the destination operations may optionally use a port type binding attribute, for example portTypeBinding, to reference a specific binding for the operation.

Extension element 32′ also preferably comprises a conversation name extension attribute 37′. Following is a definition for conversation name extension attribute 37′:

<xsd:attribute name=“name” type=“xsd:NMTOKEN” use=“required”/>

According to the above example, a conversation name attribute 37 of web-services interface 18 (FIG. 4A) preferably comprises a name for the web-service conversation defined by conversation element extension 32 of web-services interface 18. Conversation name attribute 37 is of type NMTOKEN. NMTOKEN is preferably a name token comprising of one or more characters, such as alphabets, digits, hyphens, underscores, and/or periods.

In the exemplary schema of APPENDIX A, following the extension definition element is an operation definitions element which defines an element of type referencedOperation. Following is a definition for the operation definitions element:

<xsd:complexType name=“referencedOperation”>

<xsd:annotation>

<xsd:documentation>References the name attribute of
an operation
defined in a port type.</xsd:documentation>

</xsd:annotation >
<xsd:simpleContent>

<xsd:extension base=“xsd:QName”>

| | |
|---|---|
| <xsd:attribute | name=“portTypeBinding” |

type=“xsd:QName”
use=“optional”>

<xsd:annotation>

<xsd:documentation>The attribute
portTypeBinding references
a specific binding for an operation. If
omitted it means that
either there is only one binding provided
for that port type, or
that any binding may be used for this
operation in the context
of that conversation.</xsd:documentation>

</xsd:annotation>

</xsd:attribute>

</xsd:extension>

</xsd:simpleContent>

</xsd:complexType>

According to the above definition, the element referencedOperation references the name attribute of an operation defined in a port type element. The element referencedOperation may also comprise a port type binding attribute of type QName. The port type binding attribute preferably points to a binding element which may be defined in web-services interface 18. The use of port type binding attribute is optional. Preferably, the port type binding attribute references a specific binding for an operation. If omitted, it means that either there is only one binding provided for that port type or that any binding may be used for this operation in the context of this conversation.

Preferably, extension element 32′ is an extension to an element “definitions” of a WSDL document. Extension element 32′ preferably follows the rules concerning valid extensions to the definitions element in a WSDL document.

In order to make the connection between a web-service and the conversations supported by the web-service, a services element (not shown) of web-services interface 18 may comprise a conversation properties extension element 49′. Following is a definition for conversation properties extension element 49′:

<xsd:element name=“conversationProperties” type=“conv:conversationProperties Type”/>

Conversation properties extension element 49′ is of type conversationPropertiesType. In the example of APPENDIX A, a conversation properties definition element defines an element of type conversationPropertiesType. Following is a definition for the conversation properties definition element:

<xsd:complexType name=“conversationPropertiesType”>

. . .
<xsd:attribute name=“required” type=“xsd:boolean”
use=“required” default
=“true”/>

</xsd:complexType>

The conversation properties definition element comprises a sequence sub-element xsd:sequence and a “required” attribute. Following is a definition for the sequence sub-element:

<xsd:sequence>

<xsd:element name=“conversations”>

<xsd:complexType>

<xsd:sequence>

| | |
|---|---|
| <xsd:element | name=“conversation” |

type=“xsd:QName”
maxOccurs=“unbounded”>

. . .

</xsd:element>

</xsd:sequence>

</xsd:complexType>

</xsd:element>

</xsd:sequence>

According to the above example, conversation properties extension element 49′ comprises the following conversation definitions sub-element:

<xsd:element name=“conversation” type=“xsd:QName”

maxOccurs=“unbounded”>
<xsd:annotation>

<xsd:documentation>References the name attribute of
a WSDL extension
element definitions/conversation.</xsd:documentation>

</xsd:annotation>

</xsd:element>

According to the above conversation definitions sub-element, a conversation properties element 49 of web-services interface 18 comprises of a conversation element of type QName. A conversation element preferably references the name attribute of a conversation element extension for a web-service. The conversation element has no minimum occurrence value and a maximum occurrence (maxOccurs) value of “unbounded”, which indicates that a conversation properties element 49 may comprise of one or more conversation elements.

Following is a definition for the “required” attribute of the conversation properties definition element:

<xsd:attribute name=“required” type=“xsd:boolean” use=“required” default=“true”/>

The above attribute indicates whether or not an actor has to observe the supported conversation and whether or not an actor has to provide a conversation instance identification, for example in a sub-element of the BizTalk header of a message. The attributed is of type “boolean” indicating that it may be “true” or “false”. According to the above example, the use of the above attribute in web-services interface 18 is required and the default value is “true.”

FIG. 4A is an exemplary web-services interface 18 that comprises a conversation element extension 32 in accordance with an embodiment of the present invention. FIG. 4B illustrates an exemplary finite state machine 30 corresponding to the exemplary web-services interface 18 of FIG. 4A. Web-services interface 18 is an exemplary web-services interface generated by service provider 12 and made available to service requestor 14. Preferably, web-services interface 18 is a WSDL document. Conversation element extension 32 complies with schema 34 of FIG. 3. Service provider 12 defines additional information about a web-service in conversation element extension 32 and informs service requestor 14 about the sequence in which operations within the web-service supported by service provider 12 may be invoked. A conversation between service provider 12 and service requester 14 is preferably modeled using one or more finite state machines (FSM), for example FSM 30 of FIG. 4B. Preferably, conversation element extension 32 supports conversations between two actors. If service requestor 14 desires to talk to more than one service provider simultaneously, then separate conversations may be initiated by service requestor 14. Preferably, each of the actors in a conversation relating to a web-service has access to a copy of web-services interface 18 for that particular web-service. Preferably, conversation element extension 32 supports sequential conversations, i.e. conversations where there is no forking or joining of conversations or conversations where one conversation does not depend on another conversation taking place at the same time. However, if desired, multiple simultaneous conversations between two actors may be supported.

Web-services interface 18 comprises a message element 31, a port type element 33, and a conversation element extension 32. Message element 31 defines one or more operation messages for the web-service. In the example of APPENDIX B, a plurality of operation messages are defined, for example a registration request (RegistrationRQ), a registration response (RegistrationRS), a login request (LoginRQ), two login responses (ValidLoginRS and InvalidLoginRS), a purchase request (PurchaseRQ), three purchase responses (PurchaseAcceptedRS, OutOfStockRS, and InvalidPaymentRS), a logout operation message (LogoutMessage), and a shipping operation message (ShippingInformation).

Port type element 33 preferably defines a plurality of operations, for example operations 33₁ through 33₅ of FIG. 4B, which form part of the web-service being defined. Each of the plurality of operations 33₁ through 33₅ is denoted by a node in FSM 30 of FIG. 4B. An example of a port type element is provided below:

<portType name=“SimpleStoreFront”>

<operation name=“Registration”>

. . .

</operation>
<operation name=“Login”>

. . .

</operation>
<operation name=“Purchase”>

. . .

</operation>
<operation name=“Logout”>

. . .

</operation>
<operation name=“Shipping”>

. . .

</operation>

</portType>

In the above example, five operations are defined, namely, Registration 33₁, Login 33₂, Purchase 33₃, Logout 33₄ and Shipping 33₅.

An operation comprises one or more of the messages defined in message element 31. Following is a more detailed definition for each of the above operations:

<portType name=“SimpleStoreFront”>

<operation name=“Registration”>

<input message=“tns:RegistrationRQ”/>
<output message=“tns:RegistrationRS”/>

</operation>
<operation name=“Login”>

<input message=“tns:LoginRQ”/>
<output message=“tns:ValidLoginRS”/>
<fault message=“tns:invalidLoginRS”/>

</operation>
<operation name=“Purchase”>

<input message=“tns:PurchaseRQ”/>
<output message=“tns:PurchaseAcceptedRS”/>
<fault message=“tns:InvalidPaymentRS”/>
<fault message=“tns:OutOfStockRS”/>

</operation>
<operation name=“Logout”>

<input message=“tns:LogoutMessage”/>

</operation>
<operation name=“Shipping”>

<output message=“tns:ShippingInformation”/>

</operation>

</portType>

As shown in the above example, for Registration operation 33₁, an input operation message is RegistrationRQ and an output operation message is RegistrationRS 47₁; for Login operation 33₂, the input message is LoginRQ, the output message is ValidLoginRS 47₂ and a fault message is InvalidLoginRS 47₃ and 47₄; for Purchase operation 33₃, the input message is PurchaseRQ, the output message is PurchaseAcceptedRS 47₆ and the fault messages are OutOfStockRS 47₈ and 47₉, and InvalidPaymentRS 47₅ and 47₇; for Logout operation 33₄, the input message is LogoutMessage; and for Shipping operation 33₅, the output message is ShippingInformation.

Although port type element 33 defines the plurality of operations supported by the web-service, it does not specify the sequence in which those operations may be requested or invoked. If service requestor 14 does not know the sequence in which the operations may be requested or invoked, service requestor 14 may try to invoke an operation in the incorrect sequence resulting in an invalid message being generated. For example, if service requester 14 tries to invoke Purchase operation 33₃ without having invoked Login operation 33₂, an invalid message may be generated.

Exemplary web-services interface 18 also provides conversation element extension 32. In accordance with an embodiment of the present invention, conversation element extension 32 preferably comprises a plurality of elements. Preferably, conversation element extension 32 comprises of the elements specified by schema 34, such as a conversation name attribute 37, a namespace element 39, a conversation port types element 41, an initial operations element 43, a final operations element 45, a transitions element 47, and a conversation properties element 49. Following is an example of conversation element extension 32:

<conv:conversation name=“SimpleStoreFrontConversation”

xmlns:conv=“http://schemas.hp.com/web-services/wsdl/conversations”>

<conv:portTypes><conv:portType>SimpleStoreFront</conv:portType></conv:port
Types>
<conv:initialOperations>

. . .

</conv:initialOperations>
<conv:finalOperations>

. . .

</finalOperations>
<conv:transitions>

<conv:transition>

. . .

</conv:transition>

</conv:transitions>
</conv:conversation>
. . .
<conv:conversationProperties required=“true”>

<conv:conversations>

<conv:conversation>SimpleStoreFrontConversation</conv:conver
sation>

</conv:conversations>

</conv:conversationProperties>

Conversation name attribute 37 defines a name for the conversation being defined. Namespace element 39 preferably specifies a unique identifier, for example a URL, that may be used to refer to an extension to a specification, for example a conversation element extension to a specification of a web-services description language. Following is an exemplary conversation name attribute and an exemplary namespace element:

<conv:conversation name=“SimpleStoreFrontConversation”

xmlns:conv=“http://schemas.hp.com/web-services/wsdl/conversations”>

In the above example, the name of the conversation being defined is SimpleStoreFrontConversation. Furthermore, the elements or sub-elements starting with conv are defined by the specification extension referenced by the unique identifier (http://schemas.hp.com/web-services/wsdl/conversations). Preferably, the unique identifier corresponds to the unique identifier specified in target namespace element 39′ of schema 34.

Following is an example of conversation port types element 41:

<conv:portTypes><conv:portType>SimpleStoreFront</conv:portType></conv:portTypes>

In the above example, conversation port types element 41 refers back to a plurality of port types as previously defined in port type element 33.

Following is an example of initial operations element 43:

<conv:initialOperations>

<conv:initialOperation>tns:Login</conv:initialOperation>
<conv:initialOperation>tns:Registration</conv:initialOperation>

</conv:initialOperations>

According to the above example, the two possible initial operations for the web-service are Login and Registration.

Following is an example of final operations element 45:

<conv:finalOperations>

<conv:finalOperation>tns:Shipping</conv:finalOperation>
<conv:finalOperation>tns:Logout</conv:finalOperation>

</finalOperations>

According to the above example, the two possible final operations for the web-service are Shipping and Logout.

Following is an example of transitions element 47:

<conv:transitions>

<conv:transition><conv:sourceOperation>tns:Registration</conv:sourceOpera
tion>

<conv:destinationOperation>tns:Login</conv:destinationOperation>

</conv:transition>
<conv:transition><conv:sourceOperation>tns:Login</conv:sourceOperation>

<conv:destinationOperation>tns:Purchase</conv:destinationOperation>
<conv:sourceOperationCondition>tns:ValidLoginRS</conv:sourceOper
ationCondition>

</conv:transition>
. . .

</conv:transitions>

In the above example, only the transitions specified by the transition elements are permitted. This is referred to herein as exclusionary transitioning. In an alternative embodiment, the transition elements may be specified so that all transitions except those expressly specified are permitted. This is referred to herein as permissive transitioning. In another alternative embodiment, a combination of exclusionary transitioning and permissive transitioning may be used.

The enabled transitions of APPENDIX B are shown in FSM 30 of FIG. 4B as directional arrows from a source operation to a destination operation with the arrows being labeled by the corresponding transition conditions. For example, as illustrated, in order to transition from Login operation 33₂ to Purchase operation 33₃, the following transition element is defined:

<conv:transition><conv:sourceOperation>tns:Login</conv:sourceOperation>

<conv:destinationOperation>tns:Purchase</conv:destinationOperation>
<conv:sourceOperationCondition>tns:ValidLoginRS</conv:sourceOpera
tionCondition>

</conv.transition>

In the above transition element, Login operation 33₂ is specified as the source operation and Purchase operation 33₃ is specified as the destination operation. The transition condition for transitioning from Login operation 33₂ to Purchase operation 33₃ is a valid login response message, for example ValidLoginRS 314

The remaining transitions defined by web-services interface 18 of APPENDIX B and FIG. 4B are self-explanatory and are not discussed in detail herein. It should be clear from the example of APPENDIX B and FIG. 4B, that an operation may be the source operation for multiple transitions and an operation may be the destination operation for multiple transitions. If desired, for a particular transition, the same operation may be the source operation and the destination operation.

Web-services interface 18 may comprise one or more services element (not shown). The services element defines a service. It also references the conversations supported by the service. Following is an example of the services element:

<service name=“SimpleSellingService”>

<service name=“SimpleSellingService”>

. . .
<conv:conversationProperties required=“true”>

. . .

</conv:conversationProperties>

</service>

The services element comprises conversation properties element 49, which refers to one or more conversations. Conversation properties element 49 is preferably part of a conversation element extension for a web-service defined in accordance with an embodiment of the present invention (FIG. 4A).

Following is an example of a conversation properties element:

<conv:conversationProperties required=“true”>

<conv:conversations>

<conv:conversation>SimpleStoreFrontConversation
</conv:conver
sation>

</conv:conversations>

</conv:conversationProperties>

In the above example, the conversation properties element comprises an attribute, for example required, and a conversations sub-element, for example conv:conversations. The conversations sub-element specifies one or more conversations supported by the web-service. In the above example, the conversations sub-element refers back to previously defined conversations SimpleStoreFrontConversation. According to the above exemplary attribute “required”, an actor has to observe the supported conversation and has to provide a conversation instance identification, for example in a sub-element of the BizTalk header of a message.

Preferably, conversation element extension 32 supports conversations with different levels of complexity with different specifications being used for the different levels. At level 1, a conversation may be for one port type and may use the operations for that port type. For a level 1 conversation, zero or one port types may be listed under a conversation port types element 41, for example SimpleStoreFront. At level 2, a conversation may span multiple port types and may reference operations for the different port types, For a level 2 conversation, preferably all the port types are listed under conversation port types element 41. At level 3, a conversation may span multiple port types and bindings may be specified so that transitions may be triggered by operations invoked using one or more of the specified bindings. Preferably, this level is used if a web-services interface specifies more than one binding for a port type and more than one binding is used by a specific service. At level 3, preferably the optional port type binding attribute may be used.

The appropriate level depends on how one or more of the following are specified in the web-services interface: port types, port type bindings and/or services. For example, if the functionality of a service is split into a plurality of small-grained port types, then preferably conversations span more than one port type. On the other hand, if a plurality of bindings are defined for each port type and a specific service requires a particular combination of bindings for specific conversations, then the conversation description is preferably level 3. A level 3 conversation may be, for example, one in which most operations use HTTP (Hypertext Transfer Protocol) but some are handled over email.

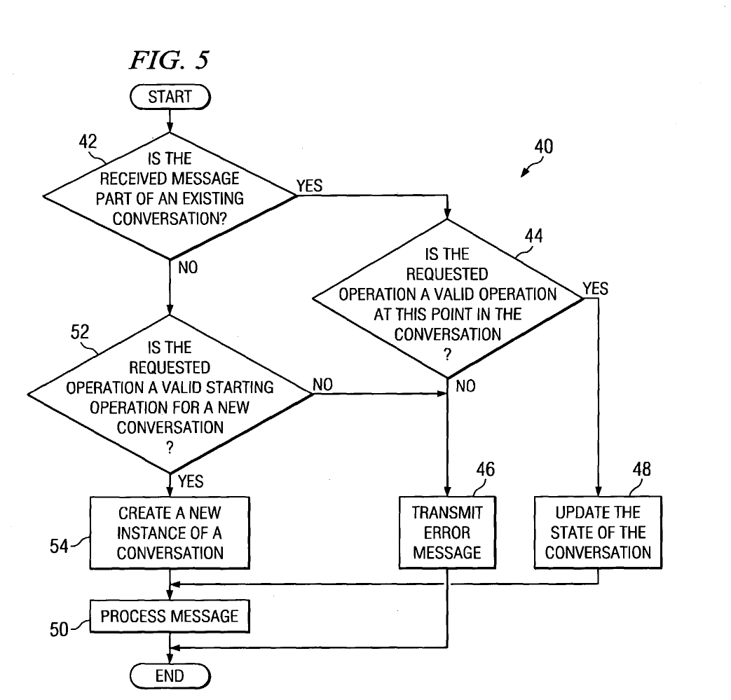

FIG. 5 is a flowchart of an exemplary method 40 for processing, by an actor, a message in accordance with an embodiment of the present invention. The actor may be a service provider and/or a service requestor. Method 40 is preferably executed by an actor upon receipt of a message. In block 42, a determination is made as to whether the received message is part of an existing conversation. In the preferred embodiment, this determination may be made by comparing a conversation identifier of the received message with conversation identifiers of existing conversations. If the received message is part of an existing conversation, then in block 44, a determination is made as to whether the requested operation is a valid operation at this point in the conversation. In the preferred embodiment, this determination is made by determining whether the web-services interface defines a transition from a preceding operation to the requested operation. If the web-services interface does not define a transition from the preceding operation to the requested operation, then the requested operation is not a valid operation at this point in the conversation. If the web-services interface defines a transition from the preceding operation to the requested operation, then a determination is made as to whether the defined transition comprises a transition condition. If the defined transition does not comprise a transition condition, then the requested operation is a valid operation. If the defined transition comprises a transition condition then a determination is made as to whether the transition condition has been met. If the transition condition has been met, then the requested operation is a valid operation. Otherwise, the requested operation is not a valid operation. For example, for the web-service defined in part by web-services interface 18, if the requested operation is a Shipping operation, then this determination may be made by checking if the previous operation in this conversation was a Purchase operation and if so, whether the received message is a PurchaseAcceptedRS message.

If in block 44, it is determined that the requested operation is not a valid operation, then in block 46, an error message may be transmitted to the actor from whom the message was received. If in block 44, it is determined that the requested operation is a valid operation, then in block 48, the state of the conversation is updated. Preferably, the state of the conversation is updated to the requested operation. In block 50, the received message is processed.

If in block 42, it is determined that the received message is not part of an existing conversation, then in block 52, a determination is made as to whether the requested operation is a valid starting operation for a new conversation. In the preferred embodiment, this determination may be made by checking the web-services interface for the corresponding web-service to determine if the requested operation is a valid initial operation, for example by determining if the requested operation is part of initial operations element 43 of web-services interface 18. If the requested operation is part of initial operations element 43 of web-services interface 18, then the operation is a valid starting operation for a new conversation. Otherwise, the operation is not a valid starting operation for a new conversation.

If the requested operation is not a valid starting operation for a new conversation, then in block 46, an error message may be transmitted to the actor from whom the message was received. If in block 52, it is determined that the requested operation is a valid starting operation for a new conversation, then in block 54, a new instance for a conversation is created between the actor from whom the message was received and the actor receiving the message. In block 50, the received message is processed.

The present invention may be implemented in software, hardware, or a combination of both software and hardware. The software and/or hardware may reside on service provider web-services server 22 and/or service requestor agent 24.

If desired, the different functions discussed herein may be performed in any order and/or concurrently with each other. Furthermore, if desired, one or more of the above described functions may be optional or may be combined without departing from the scope of the present invention.

A technical advantage of an exemplary embodiment of the present invention is that a service provider receiving a web-services message is able to determine whether a requested operation has been received in the correct sequence. Another technical advantage of an exemplary embodiment of the present invention is that a service requestor is able to determine the sequence in which operations may be requested from a service provider.

### APPENDIX

### Appendix A

<xsd:schema targetNamespace=“http://schemas.hp.com/web-services/
wsdl/conversations”>
<xsd:element name=“conversation” type=“conv:conversationType”/>
<xsd:complexType name=“conversationType”>

<xsd:sequence>

<xsd:element name=“portTypes” minOccurs=“0”>

<xsd:annotation>

<xsd:documentation>Gives a list of the port types
from
which operations appear in this conversation.
</xsd:docu
mentation>

</xsd.annotation>
<xsd:complexType>

<xsd:sequence>

<xsd:element name=“portType”
type=“xsd:QName” maxOccurs=“unbounded”/>

</xsd:sequence>

</xsd:complexType>

</xsd:element>
<xsd:element name=“initialOperations”>

<xsd:complexType>

<xsd:sequence>

<xsd:element name=“initialOperation”
type=“conv:referencedOperation”
maxOccurs=“unbounded”/>

</xsd:sequence>

</xsd:complexType>

</xsd:element>
<xsd:element name=”finalOperations”>

<xsd:complexType>

<xsd:sequence>

<xsd:element name=“finalOperation”
type=“conv:referencedOperation”
maxOccurs=“unbounded”/>

</xsd:sequence>

</xsd:complexType>

</xsd:element>
<xsd:element name=“transitions”>

<xsd:complexType>

<xsd:sequence>

| | |
|---|---|
| <xsd:element | name=“transition” |

minOccurs=“0” maxOccurs=“unbounded”>

<xsd:complexType>
<xsd:sequence>
<xsd:element name=“sourceOperation”
type=“conv:referencedOperation”/>
<xsd:element
name=“destinationOperation”
type=“conv:referencedOperation”/>
<xsd:element name=“sourceOperation
Condition” type=“xsd:QName”
minOccurs=“0”>

<xsd:annotation>
<xsd:documentation>References
the name of an input, output, or
fault message of the
sourceOperation.
</xsd:documentation>
</xsd:annotation>

</xsd:element>
</xsd:sequence>
</xsd:complexType>

</xsd:element>

</xsd:sequence>

</xsd:complexType>

</xsd:element>

</xsd:sequence>
<xsd:attribute name=“name” type=“xsd:NMTOKEN” use=“required”/>

</xsd:complexType>
<xsd:complexType name=“referencedOperation”>

<xsd:annotation>

<xsd:documentation>References the name attribute of an
operation
defined in a port type.</xsd:documentation>

</xsd:annotation>
<xsd:simpleContent>

<xsd:extension base=“xsd:QName”>

<xsd:attribute name=“portTypeBinding” type=“xsd:QName”
use=“optional”>

<xsd:annotation>

<xsd:documentation>The attribute
portTypeBinding references a specific binding
for an operation. If omitted it means that either
there is only one binding provided for that port
type, or that any binding may be used for this
operation in the context of that
conversation.</xsd:documentation>

</xsd:annotation>

</xsd:attribute>

</xsd:extension>

</xsd:simpleContent>

</xsd:complexType>
<xsd:elementname=“conversationProperties”
type=“conv:conversationPropertiesType”/>
<xsd:complexType name=“conversationPropertiesType”>

<xsd:sequence>

<xsd:element name=“conversations”>

<xsd:complexType>

<xsd:sequence>

<xsd:element name=“conversation”
type=“xsd:QName” maxOccurs=“unbounded”>

<xsd:annotation>

<xsd:documentation>References
the name attribute of a
conversation
extension element definitions/con
versation.</xsd:documentation>

</xsd:annotation>

</xsd:element>

</xsd:sequence>

</xsd:complexType>

</xsd:element>

</xsd:sequence>
<xsd:attribute name=“required” type=“xsd:boolean”
use=“required”
default=“true”/>

</xsd:complexType>
</xsd:schema>

### Appendix B

<import namespace=“http://example.com/mySellingServices/messageschemas” . . . />
<message name=“RegistrationRQ”> <part name=“body” element=“xsdl:RegistrationRQDat
a”/> </message>
<message name=“RegistrationRS”> <part name=“body” element=“xsdl:RegistrationRSData
”/> </message>
<message name=“LoginRQ”> <part name=“body” element=“xsdl:LoginRQData”/> </mes
sage>
<message name=“ValidLoginRS”> part name=“body” element=“xsdl:LoginRSData”/> </m
essage>
<message name=“InvalidLoginRS”> <part name=“body” element=“xsdl:LoginRSData”/>
</message>
<message name=“PurchaseRQ”> <part name=“body” element=“xsdl:PurchaseData”/> </
message>
<message name=“PurchaseAcceptedRS”> <part name=“body” element=“xsdl:PurchaseRes
ponseData”/> </message>
<message name=“OutOfStockRS”> <part name=“body” element=“xsdl:PurchaseResponse
Data”/> </message>
<message name=“InvalidPaymentRS”> <part name=“body” element=“xsdl:InvalidPayment
Data”/> </message>
<message name=“LogoutMessage”> <part name=“body” element=“xsdl:LogoutData”/> </
message>
<message name=“ShippingInformation”> <part name=“body” element=“xsdl:ShippingData
”/> </message>
<portType name=“SimpleStoreFront”>

<operation name=“Registration”>

<inputmessage=“tns:RegistrationRQ”/>
<outputmessage=“tns:RegistrationRS”/>

</operation>
<operation name=“Login”>

<input message=“tns:LoginRQ”/>
<output message=“tns:ValidLoginRS”/>
<faultmessage=“tns:invalidLoginRS”/>

</operation>
<operation name=“Purchase”>

<input message=“tns:PurchaseRQ”/>
<output message=“tns:PurchaseAcceptedRS”/>
<fault message=“tns:InvalidPaymentRS”/>
<fault message=“tns:OutOfStockRS”/>

</operation>
<operation name=“Logout”>

<input message=“tns:LogoutMessage”/>

</operation>
<operation name=“Shipping”>

<output message=“tns:ShippingInformation”/>

</operation>

</portType>
<conv: conversation name=“SimpleStoreFrontConversation”

xmlns:conv=“http://schemas.hp.com/web-services/wsdl/conversations”>

<conv:portTypes><conv:portType>SimpleStoreFront</conv:portType></conv:portTypes>
<conv:initialOperations>

<conv:initialOperation>tns:Login</conv:initialOperation>
<conv:initialOperation>tns:Registration</conv:initialOperation>

</conv:initialOperations>
<conv:finalOperations>

<conv:finalOperation>tns:Shipping</conv:finalOperation>
<conv:finalOperation>tns:Logout</conv:finalOperation>

</finalOperations>
<conv:transitions>

<conv:transition><conv:sourceOperation>tns:Registration</conv:sourceOperation>

<conv:destinationOperation>tns:Login</conv:destinationOperation>

</conv:transition>
<conv:transition><conv:sourceOperation>tns:Login</conv:sourceOperation>

<conv:destinationOperation>tns:Purchase</conv:destinationOperation>
<conv:sourceOperationCondition>tns:ValidLoginRS</conv:sourceOperationConditio

n>

</conv:transition>
<conv:transition><conv:sourceOperation>tns:login</conv:sourceOperation>

<conv:destinationOperation>tns:Registration</conv:destinationOperation>
<conv:sourceOperationCondition>tns:InvalidLoginRS</conv:sourceOperationConditi

on>

</conv:transition>
<conv:transition><conv:sourceOperation>tns:Login</conv:sourceOperation>

<conv:destinationOperation>tns:Login</conv:destinationOperation>
<conv:sourceOperationCondtion>tns:InvalidLoginRS</conv:sourceOperationConditi

on>

</conv:transition>
<conv:transition><conv:sourceOperation>tns:Purchase</conv:sourceOperation>

<conv:destinationOperation>tns:Shipping</conv:destinationOperation>
<conv:sourceOperationCondition>tns:PurchaseAcceptedRS</conv:sourceOperation
Condition>

</conv:transition>
</conv:transition><conv:sourceOperation>tns:Purchase</conv:sourceOperation>

<conv:destinationOperation>tns:Logout</conv:destinationOperation>
<conv:sourceOperationCondition>tns:InvalidPaymentRS</conv:sourceOperation
Condition>

</conv:transition>
<conv:transition><conv:sourceOperation>tns:Purchase</conv:sourceOperation>

<conv:destinationOperation>tns:Purchase</conv:destinationOperation>
<conv:sourceOperationCondition>tns:InvalidPaymentRS</conv:source
OperationCondition>

</conv:transition>
<conv:transition><conv:sourceOperation>tns:Purchase</conv:sourceOperation>

<conv:destinationOperation>tns:Logout</conv:destinationOperation>
<conv:sourceOperationCondition>tns:OutOfStockRS</conv:sourceOperation
Condition>

</conv:transition>
<conv:transition><conv:sourceOperation>tns:Purchase</conv:sourceOperation>

<conv:destinationOperation>tns:Purchase</conv:destinationOperation>
<conv:sourceOperationCondition>tns:OutOfStockRS</conv:sourceOperation
Condition>

</conv:transition>
</conv:transitions>

</conv:conversation>
<service name=“SimpleSellingService”>

. . .
<conv:conversationProperties required=“true”>

<conv:conversations>

<conv:conversation>SimpleStoreFrontConversation</conv:conversation>

</conv:conversations>

</conv:conversationProperties>

</service>
</definitions>

What is claimed is:

1. A web-services interface for a web-service, comprising:
an initial operations element operable to specify at least one operation of a plurality of operations of said web-service as an initial operation of said conversation;
a final operations element operable to specify at least one operation of said plurality of operations as a final operation of said conversation; and
a transitions element operable to specify a transition from at least one of said plurality of operations to at least another one of said plurality of operations.

2. The web-services interface of claim 1, wherein said transitions element is operable to specify a plurality of transitions operable to transition said conversation from said initial operation to said final operation.

3. The web-services interface of claim 1, wherein said transitions element comprises:
a source operation for said transition; and
a destination operation for said transition, wherein said conversation is operable to transition from said source operation to said destination operation.

4. The web-services interface of claim 3, wherein said transitions element further comprises a transition condition which when true is operable to facilitate said transition from said source operation to said destination operation.

5. The web-services interface of claim 1, further comprising a conversation port types element operable to define said plurality of operations of said web-service.

6. The web-services interface of claim 1, further comprising a conversation port types element operable to reference said plurality of operations of said web-service.

7. The web-services interface of claim 1, wherein each of said plurality of operations comprises:
an operation name for an associated operation of said plurality of operations; and
at least one operation message for said associated operation.

8. The web-services interface of claim 1, further comprising a conversation properties element operable to reference a conversation element extension comprising said initial operations element, said final operations element and said transitions element.

9. The web-services interface of claim 1, wherein said conversation comprises an exchange of a plurality of messages between a service provider and a service requestor.

10. The web-services interface of claim 1, wherein said web-services interface is operable to specify a sequence in which said plurality of operations are permitted to be invoked.

11. The web-services interface of claim 1, wherein said web-services interface comprises a web-services description language interface.

12. The web-services interface of claim 1, wherein said web-services interface comprises a web-services description language document.

13. A method for defining a web-service, comprising defining a web-services interface for said web-service, said web-services interface comprising a conversation element extension operable to inform a service requestor regarding a predetermined order for invoking a plurality of operations of said web-service.

14. The method of claim 13, wherein said defining comprises defining a web-services description language document for said web-service.

15. The method of claim 13, wherein said defining comprises specifying at least one operation of said plurality of operations as an initial operation of a conversation.

16. The method of claim 13, wherein said defining comprises specifying at least one operation of said plurality of operations as a final operation of a conversation.

17. The method of claim 13, wherein said defining comprises specifying a transition from at least one of said plurality of operations to at least another one of said plurality of operations.

18. The method of claim 15, further comprising specifying a plurality of transitions for transitioning said conversation from said initial operation to said final operation.

19. The method of claim 17, wherein said specifying said transition comprises specifying a source operation for said transition.

20. The method of claim 19, wherein said specifying said transition further comprises specifying a destination operation for said transition, wherein said conversation is operable to transition from said source operation to said destination operation.

21. The method of claim 19, further comprising specifying a transition condition which when true facilitates said transition from said source operation to said destination operation.

22. The method of claim 13, further comprising defining said plurality of operations of said web-service.

23. The method of claim 13, further comprising defining a conversation port types element operable to reference said plurality of operations of said web-service.

24. The method of claim 13, wherein said defining comprises specifying an operation name for each of said plurality of operations.

25. The method of claim 13, wherein said defining comprises specifying at least one operation message for each of said plurality of operations.

26. The method of claim 13, wherein said defining comprises defining a conversation properties element referencing said conversation element extension.

27. A method for providing a web-service, comprising:
determining whether a received message is part of an existing conversation;
determining whether a web-services interface for said web-service defines a transition from a preceding operation to an operation requested by said message, in response to said message being part of an existing conversation;
updating a state of said existing conversation to said operation requested by said message in response to said web-services interface defining a transition from said preceding operation to said requested operation; and
processing said message.

28. The method of claim 27, wherein said determining whether said received message is part of said existing conversation comprises comparing a conversation identifier of said received message with a conversation identifier of at least one existing conversation.

29. The method of claim 27, further comprising transmitting an error message in response to said web-services interface not defining a transition from said preceding operation to said requested operation.

30. The method of claim 27, further comprising:
determining whether a transition condition for transitioning from said preceding operation to said requested operation is defined; and
determining whether said message satisfies said transition condition in response to said transition condition being defined.

31. The method of claim 30, further comprising updating said state of said existing conversation to said requested operation in response to said transition condition being satisfied.

32. The method of claim 27, further comprising:
determining whether said requested operation is a valid initial operation for said web-service, in response to said message not being part of an existing conversation; and
transmitting an error message in response to said requested operation not being a valid initial operation for said web-service.

33. The method of claim 27, further comprising:
determining whether said requested operation is a valid initial operation for said web-service, in response to said message not being part of an existing conversation; and
creating a new conversation instance in response to said requested operation being a valid initial operation for said web-service.
